(19) United States
(12) Patent Application Publication
(10) Pub. No.: US 2018/0142372 A1
(43) Pub. Date: May 24, 2018

(54) Method of manufacturing copper composite electrode

(71) Applicant: National Chung Hsing University, Taichung (TW)

(72) Inventors: Ching-Chou WU, Taichung (TW); Ming-Yuan LEE, Nantou (TW)

(21) Appl. No.: 15/598,588

(22) Filed: May 18, 2017

(30) Foreign Application Priority Data
Nov. 18, 2016 (TW) 105137920

(51) Int. Cl. C25D 5/48; H01B 1/08; H01B 13/00; C25D 5/34; C25D 3/38; C25D 9/04

(52) U.S. Cl. CPC C25D 5/48; H01B 1/08; C25D 9/04; C25D 5/34; C25D 3/38; H01B 13/0036

(57) ABSTRACT

A method for manufacturing a copper composite electrode, including contacting a conductive substrate including copper with a phosphate solution for oxidation to produce a copper phosphate structure on a surface of the conductive substrate, thus acquiring a copper phosphate composite electrode.

### BACKGROUND OF THE INVENTION

### Field of the Invention

The invention relates to a detection tool, more particularly to a method for manufacturing a copper composite electrode.

### Description of the Related Art

Copper electrode is cheap and one of the commonly used materials in the electrochemical detection at present. However, the long-term stability of the copper electrode is not good, and copper composite electrode is therefore used as a substitute in the electrochemical detection. Compared with other copper composite material, copper phosphate composite material as the electrode is demonstrated to possess excellent long-term stability, but the manufacture process thereof is relatively complicated. For example, a copper foil requires to be treated by oxidative etching using strong phosphoric acid for several hours (Wu et al., 2005; Wu and Shi, 2005), or by multi-step electrochemical oxidation and chemical dissolution-precipitation (Lee et al., 2015), which all require several hours of treatment to prepare the copper phosphate composite material, and therefore restrict the wide application of the copper phosphate composite material in detection tools or platforms.

In a word, the preparation methods of the copper phosphate electrode in the prior art have the problems of low convenience, high price, too long manufacturing time, etc. In order to tackle such problems, it is desired to develop a method for prepare a copper phosphate composite electrode.

### SUMMARY OF THE INVENTION

In view of the above-described problem, it is one objective of the invention to provide a method for manufacturing a copper composite electrode. The method adopts oxidation between a conductive substrate and a phosphate solution to yield a copper phosphate structure on a surface of the conductive substrate. Not only is the time of the preparation of the copper composite electrode shortened, but also the chemical stability of the copper composite electrode is improved and the production cost thereof is reduced. Thus, the method is applicable to large scale production of the copper composite electrode, and the costs for detection and production are lowered.

To achieve the above objective, in accordance with one embodiment of the invention, there is provided with a method for manufacturing a copper composite electrode. The method comprises:

a) preparing a conductive substrate comprising a copper surface;

b) placing the conductive substrate comprising the copper surface in a phosphate solution to allow copper to contact with the phosphate solution for oxidation; and

c) acquiring a copper phosphate composite electrode

In the embodiments of this invention, when the conductive substrate is a non-copper conductive substrate, the non-copper conductive substrate is pre-treated by deposition to deposit a copper structure on a surface of the non-copper conductive substrate. For example: the non-copper conductive substrate is placed in a solution comprising copper ions, and copper ions are deposited on the surface of the non-copper conductive substrate by using electrodeposition.

In the embodiments of this invention, the conductive substrate is formed by a material possessing electrical conductivity, such as copper, a scree-printed carbon electrode (SPCE), iridium tin oxide, carbon, graphite, diamond, gold, platinum, or the like.

In the embodiments, the oxidation in b) adopts electrooxidation, chemical oxidation, or a combination of alternate use thereof. When the oxidation in b) adopts the chemical oxidation, an oxidant is added, and the oxidant is hydrogen peroxide, potassium ferrite, potassium permanganate, and potassium dichromate, or the like. For example, when the oxidant is hydrogen peroxide, a molar concentration of hydrogen peroxide is between 0.001 and 10 M, for example, 0.001, 0.05, 0.1, 0.2, 0.3, 0.5, 0.6, 0.8, 0.9, 1, 2, 5, 7, 9, or 10 M.

In the embodiments of the present invention, a molar concentration of a phosphate of the phosphate solution in b) is between 0.001 and 5 M, for example a molar concentration of the phosphate of 0.001, 0.01, 0.05, 0.1, 0.15, 0.2, 0.5, 0.6, 0.7, 0.8, 1.0, 1.1, 1.5, 1.8, 2.0, 3.0, 4.0 or 5.0 M in the phosphate solution is able to reach the objective of the invention.

In the embodiments of the present invention, a pH value of the phosphate solution in b) is between 3.0 and 6.5. For example, the pH value of the phosphate solution is 3.0, 3.5, 4.0, 5.0, 5.5, 6.0, or 6.5.

In one embodiment of this invention, in order to improve the stability of the copper phosphate composite electrode in environments of different pH values, the copper phosphate composite electrode is further modified.

In other embodiments, the copper composite material prepared by the above method is coated with an ionic liquid or a negatively charged polymer film on a surface thereof to enhance the stability. When the ionic liquid is adopted to modify the surface of the copper phosphate composite electrode, the ionic liquid is coated on the surface of the copper phosphate composite electrode to form a modified layer of a set thickness, thus modifying the copper phosphate composite electrode; and the set thickness is approximately between 0.1 μm and 1.0 mm When the negatively charged polymer film is adopted to modify the surface of the copper phosphate composite electrode, a thickness of a modified layer formed by the negatively charged polymer film on the surface of the copper phosphate composite electrode is between 0.1 μm and 1.0 mm

In the embodiments of the invention, an ionic liquid-modified surface of the copper phosphate composite electrode is performed with a secondary modification, that is, the negatively charged polymer film is adopted to modify the ionic liquid-modified surface of the copper phosphate composite electrode, and a modified thickness of the negatively charged polymer film is approximately between 0.1 μm and 1.0 mm In addition, for instance, the negatively charged polymer film is selected from the group consisting of Nafion, a sulfonated polyaniline, a sulfonated polystyrene ether, and a sulfonated polystyrene.

### BRIEF DESCRIPTION OF THE DRAWINGS

The invention is described herein below with reference to the accompanying drawings, in which:

FIG. 1A is a first picture illustrating a surface of Cu/SPCE observed under scanning electron microscope (SEM) in accordance with one embodiment of the invention;

FIG. 1B is a second picture illustrating a surface of Cu/SPCE observed under SEM in accordance with one embodiment of the invention;

FIG. 1C is a picture illustrating a surface of Cu/SPCE treated by electrooxidation observed under SEM in accordance with one embodiment of the invention;

FIG. 1D is a picture illustrating a surface of Cu/SPCE treated by chemical oxidation observed under SEM in accordance with one embodiment of the invention;

FIG. 1E is a picture illustrating a surface of Cu/SPCE treated by electrooxidation followed with chemical oxidation observed under SEM in accordance with one embodiment of the invention;

FIG. 1F is a picture illustrating a surface of Cu/SPCE treated by chemical oxidation followed with electrooxidation observed under SEM in accordance with one embodiment of the invention;

FIG. 2A is X-ray photoelectron spectroscopy (XPS) deconvolution waves of Cu 2p3 of Cu/SPCE after electrooxidation in accordance with one embodiment of the invention;

FIG. 2B is XPS deconvolution waves of Cu 2p3 of Cu/SPCE after chemical oxidation in accordance with one embodiment of the invention;

FIG. 3 is cyclic voltammograms of copper phosphate composite electrodes obtained in different oxidations in accordance with one embodiment of the invention; and

FIG. 4 is cyclic voltammograms of Nafion/BMPy-TFSI/Cu₃(PO₄)₂/SPCE in different solutions in accordance with one embodiment of the invention.

### DETAILED DESCRIPTION OF THE EMBODIMENTS

For further illustrating the invention, experiments detailing a method for manufacturing a copper composite electrode are described below. It should be noted that the following examples are intended to describe and not to limit the invention.

The method for manufacturing the copper composite electrode comprises: placing a copper-comprised conductive substrate in a phosphate solution, and allowing copper to react with the phosphate solution by oxidation to produce a copper phosphate structure on a surface of the conductive substrate, thus acquiring a copper phosphate composite electrode. The conductive substrate is optionally made of any conductive materials. When the conductive material is a non-copper material, the conductive substrate is placed in a solution comprising copper ions to deposit a copper structure on the surface of the non-copper conductive substrate by deposition.

The phosphate solution refers to a solution comprising phosphate-related ions, for example, NaHP₂O₄, Na₂HPO₄, K₂HPO₄, KH₂PO₄, or the like. Preferably, a pH value of the phosphate solution is between 4.5 and 6.5.

The deposition herein is also called copper structure deposition and includes chemical deposition and electrochemical deposition. In one embodiment of the invention, the non-copper conductive substrate is placed in the solution comprising copper ions with a molar concentration of between 0.001 and 5 M, and applied with a first voltage and scanned, so that the copper ions are nucleated on the surface of the non-copper conductive substrate, in which, the voltage is between −0.6 V and +0.05 V, and a scanning cycle is at least 5 cycles. In order to distribute the copper on the whole surface of the conductive substrate, a second voltage is further applied, and preferably, the second voltage is between −0.321 V and −0.072 V, and an applying time of the voltage is between 100 s and 300 s.

The oxidation herein is electrooxidation, chemical oxidation, or a combination of alternate use thereof. The electrooxidation comprises: placing the conductive substrate comprising copper in a phosphate solution having a set concentration, applying a set voltage on the phosphate solution to carry out reaction, therefore producing a copper phosphate structure on the surface of the conductive material and acquiring the copper phosphate composite electrode. The chemical oxidation comprises: placing the conductive substrate comprising copper in a mixed solution comprising a phosphate and hydrogen peroxide with set concentrations for reaction for a relatively long period to acquire a copper phosphate composite electrode.

According to embodiments of the invention, operation processes are different when using different oxidation methods, taken the following as examples:

First, the conductive substrate comprising copper is placed in a 0.001 M-5 M phosphate solution, and applied with a voltage of −0.025 V-0.1 V for 300-3600 s to acquire the copper phosphate composite electrode.

Second, the conductive substrate comprising copper is placed in a 0.001 M-5 M phosphate solution added with 0.001 M-10 M hydrogen peroxide, after 5-120 min of treatment, the copper phosphate composite electrode is acquired.

Third, the conductive substrate comprising copper is placed in the 0.001 M-5 M phosphate solution, and applied with the voltage of −0.025 V-0.1 V for 300-3600 s; thereafter, the conductive substrate comprising copper is transferred to the 0.001 M-5 M phosphate solution added with 0.001 M-10 M hydrogen peroxide, after 5-120 min of treatment, the copper phosphate composite electrode is acquired.

Fourth, the conductive substrate comprising copper is placed in the 0.001 M-5 M phosphate solution added with the 0.001 M-10 M hydrogen peroxide, after 5-120 min of treatment, the conductive substrate comprising copper is transferred to the 0.001 M-5 M phosphate solution, and applied with the voltage of −0.025 V-0.1 V for 300-3600 s to yield the copper phosphate composite electrode.

The surface modification herein refers to modify the surface of the copper phosphate composite electrode by a modifier, such as an ionic liquid or a polymer film. The modifier is coated on the surface of the copper phosphate composite electrode for a thickness of between 0.1 μm and 1.0 mm to improve the stability and sensibility of the electrode. In embodiments of the invention, the ionic liquid is preferably a TFSI-series. The polymer film is preferably negatively charged, such as Nafion, a sulfonated polyaniline, a sulfonated polystyrene ether, a sulfonated polystyrene, or the like.

In the following examples, disposable SPCE (provided by Biotest medical coporation, Taiwan) adopted as the non-copper conductive substrate was taken as an example, which was used to explain the invention but was not intended to limit the scope of the invention.

### Example 1: Preparation of Electrode

The disposable SPCE was used as a working electrode and a working area thereof was 3.14 mm², Ag/AgCl and platinum wire were respectively used a reference electrodes and an auxiliary electrode. The electrochemical experiment in this example was carried out in the form of three-electrodes.

The SPCE was firstly placed in a 100 mM phosphate solution, applied with a voltage of between −0.2 V and +1.3 V by a potentiostat and scanned for 10 cycles to clean the surface of the SPCE. After that, the SPCE was transferred to a 100 mM sodium hydrate solution and applied with a voltage of +2.0 V for 300 s to produce hydrophilic groups on the surface of the SPCE. The SPCE was then immersed in a 50 mM copper nitrate solution prepared by deionized water and having a pH value of 4.71. Copper was thereafter electrodeposited on the SPCE via the following two steps:

step 1): 50 mM Cu(NO₃)₂ solution was applied with a voltage of between −0.381 V and +0.05 V and scanned for 10 cycles to nucleate copper on carbon; and

step 2): a voltage of −0.321 V was applied for 300 s to distribute copper on the whole working region.

SPCE (also referring to Cu/SPCE hereinbelow) with a large quantity of copper deposited on the surface thereof was acquired from the above operations. Thereafter, Cu₃(PO₄)₂ composite material (also referring to Cu₃(PO₄)₂/SPCE hereinbelow) was prepared by adopting any of the following means:

Electrooxidation: the Cu/SPCE was transferred to a 1 M sodium phosphate solution having a pH value of 5.0, and applied with a voltage of −0.025 V for 1200 s to yield the Cu₃(PO₄)₂/SPCE.

Chemical oxidation: the Cu/SPCE was directly immersed in a solution comprising 1 M hydrogen peroxide and 1 M sodium phosphate, after 20 min chemical oxidation, the Cu₃(PO₄)₂/SPCE was yielded.

Comprehensive oxidation: the electrooxidation and chemical oxidation were alternately used to yield the Cu₃(PO₄)₂/SPCE.

The Cu₃(PO₄)₂/SPCE was then modified by the ionic liquid (IL) and a 0.5% Nafion membrane, and dried at room temperature for 1 hr to yield a Nafion/IL/Cu₃(PO₄)₂/SPCE.

### Example 2: Observation of Surface Structures of Cu₃(PO₄)₂/SPCE

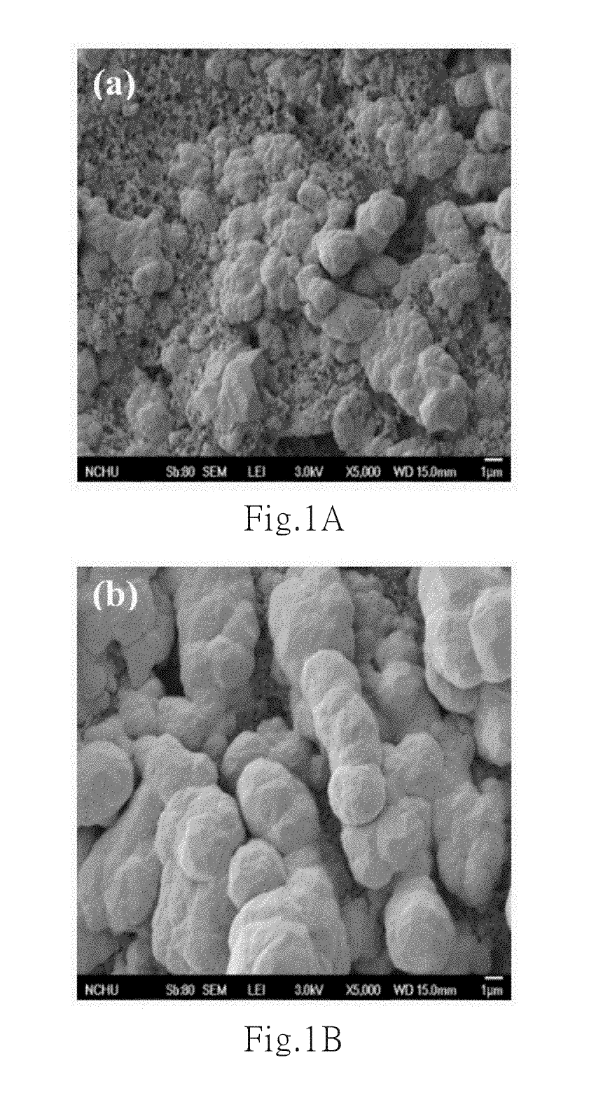

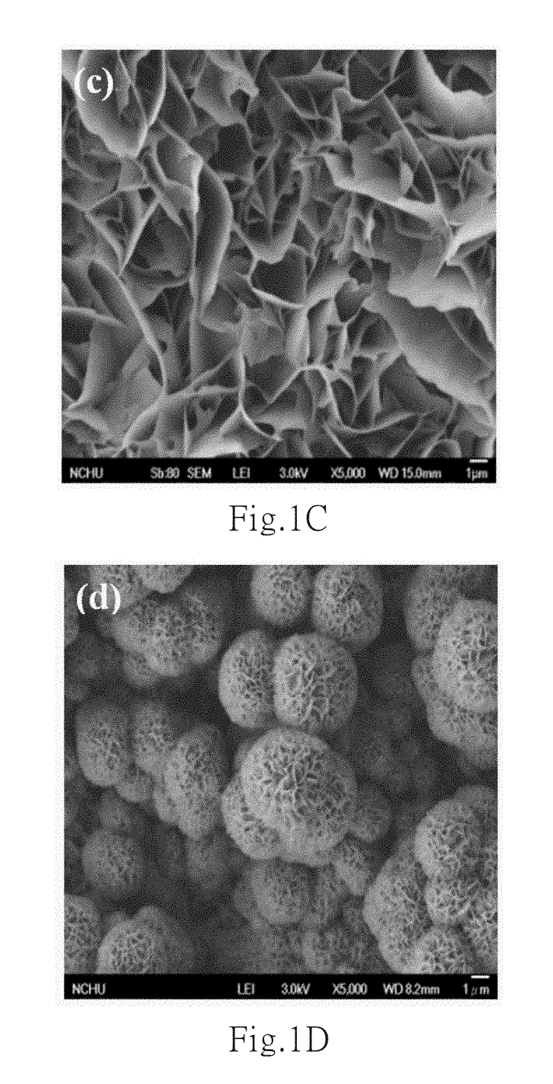

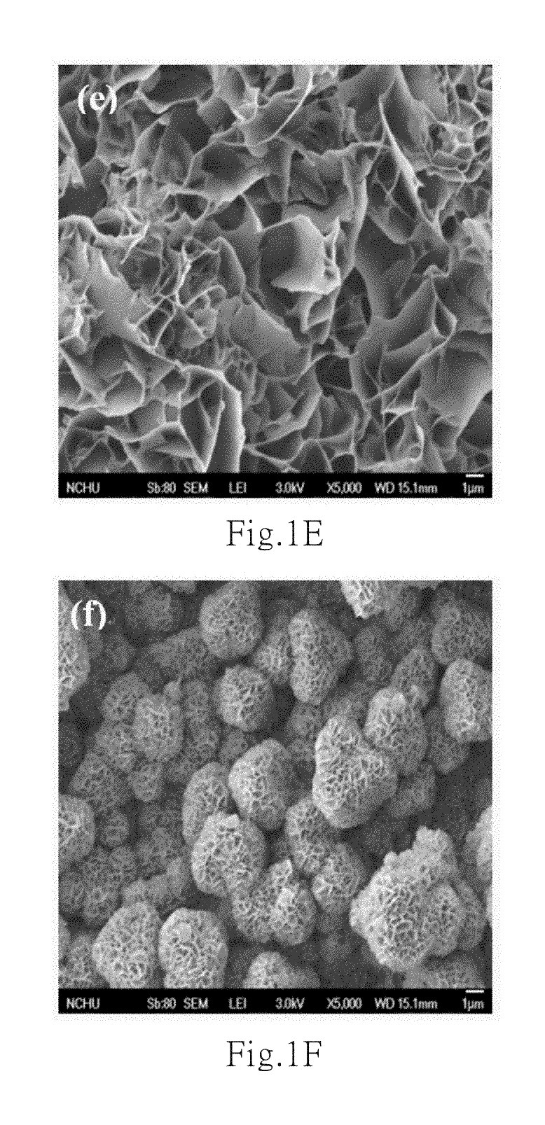

Materials during the preparation of the Cu₃(PO₄)₂/SPCE were detected by a scanning electron microscope (JEOL JSM-7401F, Japan) to observe surface structures thereof, and results were shown in FIGS. 1A-1F.

As shown in FIGS. 1A-1B, in step 1), copper was deposited on the carbon substrate by the nucleation. In step 2), the nucleated copper began to grow so that copper particles completely covered a sensing region of the SPCE. As shown in FIG. 1C, the Cu/SPCE was treated by the electrooxieation and the copper particle structure was totally transformed into relatively large flakes of copper phosphate structure. As shown in FIG. D, the Cu/SPCE was treated by the chemical oxidation for 20 min, and relatively small flakes of copper phosphate structure were formed on a surface of each copper particle. As indicated in FIG. E, by treating the Cu/SPCE with the electrooxidation followed with the chemical oxidation, relatively large flake structures were formed on the surface, which was similar to that treated by the electrooxidation. As indicated in FIG. F, by treating the Cu/SPCE with the chemical oxidation followed with the electrooxidation, relatively small flake structures were formed on the surface.

It was demonstrated from FIGS. 1A-1F that any non-copper conductive substrate after treated by the method of according to embodiments of the invention was able to yield the Cu₃(PO₄)₂ structure.

### Example 3: Detection of Chemical Compositions of Cu₃(PO₄)₂/SPCE

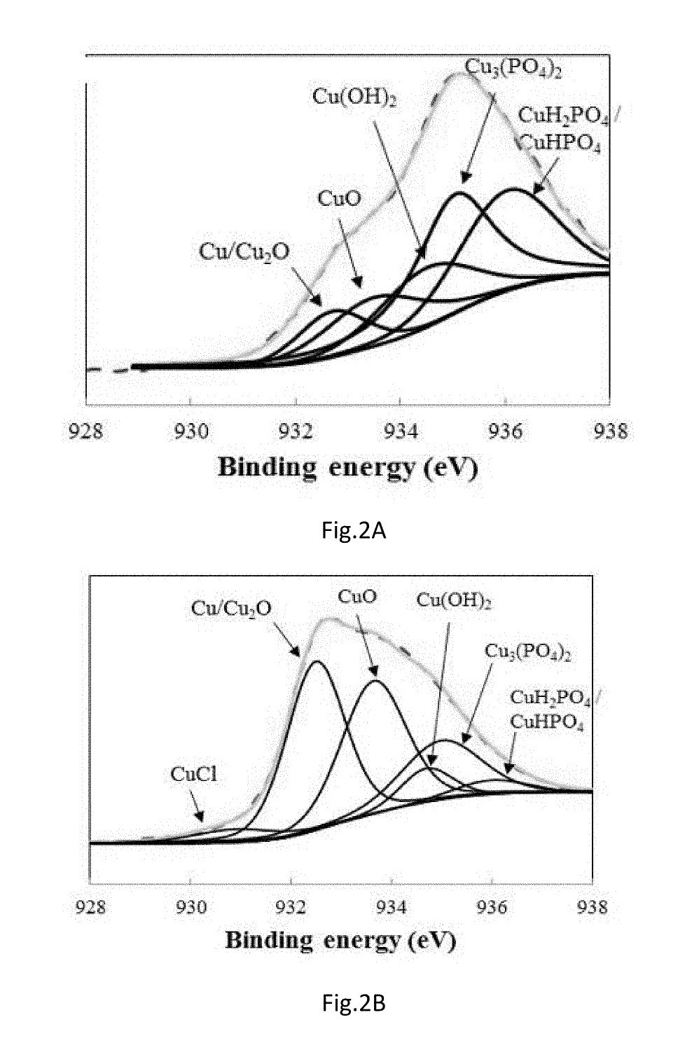

The chemical compositions of the Cu₃(PO₄)₂/SPCE were analyzed by an XPS (type: PHI 5000 VersaProbe, provided by ULVAC-PHI corporation), and results were listed in FIGS. 2A-2B and Table 1.

TABLE 1
Composition analysis of Cu 2p3 of
Cu₃(PO₄)₂/SPCE in different forms

| | Cu 2p3 composition (%) | | | | | |
|---|---|---|---|---|---|---|
| | | Cu, | | | | CuH₂PO₄/ |
| | CuCl | Cu₂O | CuO | Cu(OH)₂ | Cu₃(PO₄)₂ | CuHPO₄ |
| Electrode | 930.9 | 932.5 | 933.55 | 934.65 | 935.1 | 936 |
| treatment | (eV) | (eV) | (eV) | (eV) | (eV) | (eV) |
| Electro- | 0 | 9.1 | 13.6 | 16.1 | 33.3 | 27.9 |
| oxidation | | | | | | |
| Chemical | 3.7 | 36.5 | 31.9 | 6.5 | 17.3 | 4.0 |
| oxidation | | | | | | |

It was known from the results of this example that in the Cu₃(PO₄)₂₂/SPCE prepared by either the electrooxidation or the chemical oxidation, the Cu₃(PO₄)₂ and CuH₂PO₄/CuHPO₄ were produced, and the contents of Cu/Cu₂O and CuO were reduced. In another word, a large quantity of copper oxide and cuprous oxide produced on the Cu/SPCE were transformed into copper phosphate.

### Example 4: Electrochemical Properties of Nafion/BMPy-TFSI/Cu₃(PO₄)₂/SPCE

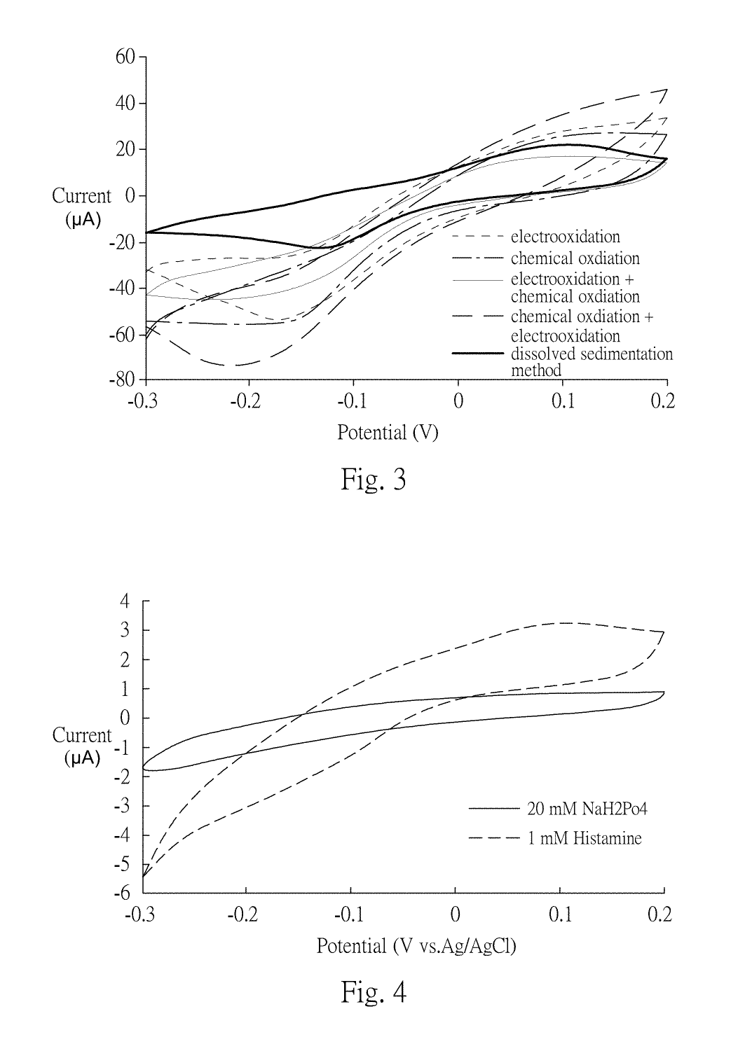

As shown in FIG. 3, electrochemical properties of the copper phosphate electrodes prepared by different methods were compared. The copper phosphate electrodes were respectively prepared by the electrooxidation, the chemical oxidation, and the comprehensive oxidation which were illustrated in Example 1, and the dissolution-precipitation method in the prior art.

It was known from the scanning in a 20 mM sodium phosphate solution having a pH value of 5.0 that the copper phosphate electrodes prepared by the four methods were different in current due to the difference of the surface areas. However, all the copper phosphate electrodes had obvious oxidation peak at the potential of +0.1 V, which meant that the four methods were able to form copper phosphate quickly.

As disclosed in the prior research, the ionic liquid comprising the TFSI anions was able to be stably coated on a copper foil of a Cu₃(PO₄)₂ composite material in a solution having a pH value of between 5 and 11 and the electrochemical stability of the resulting product was demonstrated to be good. Thus, the ionic liquid comprising N-propyl-N-methylpyrrolidinium (BMPy)-TFSI was further taken as an example, and Nafion was used to modify the BMPy-TFSI-modified Cu₃(PO₄)₂/SPCE to yield the Nafion/BMPy-TFSI/Cu₃(PO₄)₂/SPCE, which was placed in an 20 mM sodium phosphate solution having a pH value of 8.5 to detect whether 1 mM histamine was contained in the solution, and the cyclic voltammograms were shown in FIG. 4.

When histamine was contained in the solution, the increment ratio of anodic peak current ((Iₚₐ₋ₕᵢₛₜₐₘᵢₙₑ−I_{pa-blank})I_{pa-blank}) was increased by 253.8%, which indicated that the copper phosphate electrode can directly detect histamine via the histamine-Cu^{II}HPO₄ complex.

It was demonstrated from the above results that the method according to embodiments of the invention was able to prepare the copper composite electrode.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for manufacturing a copper composite electrode, the method comprising:
a) preparing a conductive substrate comprising a copper surface;
b) placing the conductive substrate comprising the copper surface in a phosphate solution to allow copper to contact with the phosphate solution for oxidation; and
c) acquiring a copper phosphate composite electrode.

2. The method of claim 1, further comprising a1) before a): collecting a non-copper conductive substrate, and depositing copper ions on a surface of the non-copper conductive substrate.

3. The method of claim 2, wherein in a1), the non-copper conductive substrate is placed in a solution comprising the copper ions to nucleate the copper ions on the surface of the non-copper conductive substrate.

4. The method of claim 1, wherein the conductive substrate is selected from the group consisting of copper, a scree-printed carbon electrode, iridium tin oxide, carbon, graphite, diamond, gold, and platinum.

5. The method of claim 1, wherein b) further comprises use of an oxidant.

6. The method of claim 5, wherein the oxidant is selected from the group consisting of hydrogen peroxide, potassium ferrite, potassium permanganate, and potassium dichromate.

7. The method of claim 5, wherein the oxidant is hydrogen peroxide, and a molar concentration of hydrogen peroxide is between 0.001 and 10 M.

8. The method of claim 1, wherein the oxidation of b) is one selected from the group consisting of electrooxidation, chemical oxidation, electrooxidation followed with chemical oxidation, and chemical oxidation followed with electrooxidation.

9. The method of claim 1, wherein a molar concentration of a phosphate of the phosphate solution in b) is between 0.001 and 5 M.

10. The method of claim 1, wherein a pH value of the phosphate solution in b) is between 3.0 and 6.5.

11. The method of claim 1, further comprising d) after c): modifying a surface of the copper phosphate composite electrode by at least one modifier, wherein the at least one modifier is selected from the group consisting of a negatively charged polymer film and an ionic liquid.

12. The method of claim 11, wherein in d), the surface of the copper phosphate composite electrode is firstly modified by the ionic liquid and then modified by the negatively charged polymer film.

13. The method of claim 11, wherein the negatively charged polymer film is selected from the group consisting of Nafion, a sulfonated polyaniline, a sulfonated polystyrene ether, and a sulfonated polystyrene.

14. The method of claim 11, wherein in d), a thickness of a modified layer formed by the negatively charged polymer film on the surface of the copper phosphate composite electrode is between 0.1 μm and 1.0 mm.

15. The method of claim 12, wherein in d), a thickness of a modified layer formed by the ionic liquid on the surface of the copper phosphate composite electrode is between 0.1 μm and 1.0 mm.
